(19) United States
(12) Patent Application Publication
(10) Pub. No.: US 2026/0244436 A1
(43) Pub. Date: Aug. 20, 2026

(54) UPGRADE OF NON-IMPORTED CONFIGURATION DATA IN A VERSION REPOSITORY DURING SOFTWARE CHANGES

(71) Applicant: SAP SE, Walldorf (DE)

(72) Inventor: Wulf Kruempelmann, Altlussheim (DE)

(21) Appl. No.: 19/059,071

(22) Filed: Feb. 20, 2025

(51) Int. Cl. G06F 8/71; G06F 8/65; G06F 16/2453

(52) U.S. Cl. CPC G06F 8/71; G06F 8/65; G06F 16/24535

(57) ABSTRACT

For a first table storing configuration data for an enterprise resource planning software application, the first table is renamed with a second name. Next, a second table is created as a separate version of the first table. Then, a first view is created of the first table, where the first view is a union of the first table and the second table, where the union is implemented with a first select clause for the first table for all clients other than a first client, and where the union is implemented with a second select clause for the second table for only the first client. Finally, one or more queries are executed by accessing first data via the first view.

### TECHNICAL FIELD

The present disclosure generally relates to upgrading non-imported configuration data in a version repository during software changes in an enterprise resource planning system.

### BACKGROUND

An application can be hosted by a cloud platform such that the application can be remotely accessible to multiple tenants, for example, over the Internet. For example, the application can be available as a cloud-based service including, for example, a software as a service (SaaS) and/or the like. Many organizations rely on such cloud-based enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. Settings and business configuration data, stored as tables, can define processes executable by the ERP and the CRM systems.

### SUMMARY

In some implementations, for a first table storing configuration data for an enterprise resource planning software application, the first table is renamed with a second name. Next, a second table is created as a separate version of the first table. Then, a first view is created of the first table, where the first view is a union of the first table and the second table, where the union is implemented with a first select clause for the first table for all clients other than a first client, and where the union is implemented with a second select clause for the second table for only the first client. Finally, one or more queries are executed by accessing first data via the first view.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a computing system, in accordance with some example implementations of the current subject matter;

FIG. 2 illustrates an example of a system including a repository for file based source code management, in accordance with some example implementations of the current subject matter;

FIG. 3 illustrates a logical diagram of a database system, in accordance with some example implementations of the current subject matter;

FIG. 4 illustrates an example of an instead-of-insert trigger, in accordance with some example implementations of the current subject matter;

FIG. 5 illustrates an example of a process for creating a view of a union of multiple tables, in accordance with some example implementations of the current subject matter;

FIG. 6 illustrates an example of a process for performing an upgrade operation of non-imported configuration data in a repository, in accordance with some example implementations of the current subject matter;

FIG. 7A depicts an example of a system, in accordance with some example implementations of the current subject matter; and

FIG. 7B depicts another example of a system, in accordance with some example implementations of the current subject matter.

### DETAILED DESCRIPTION

In modern enterprise resource planning (ERP) systems, a set of tables holds a business configuration, and periodically, this set of tables will be updated. In an ERP system, business configuration data is developed in a development system. After development, the business configuration data is transported into a test system where it is tested. Then, after testing, the business configuration data is transported into a production system for productive usage.

Between the export of the data and the import into the next system, there might be a larger timeframe, due to internal processes at the customer site. During this timeframe, there might be a software change, which might change the structure of some data. This change makes the configuration data not importable into the target system.

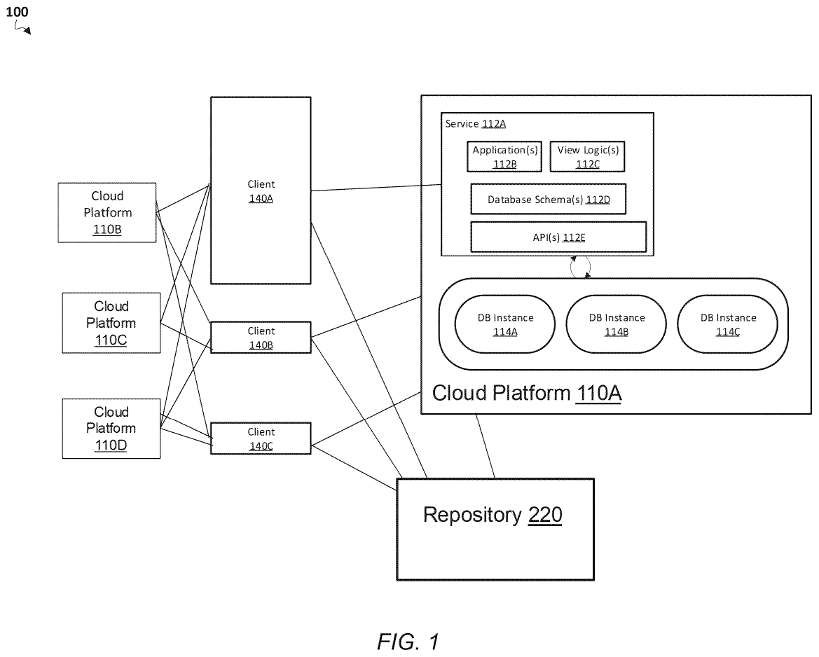

FIG. 1 depicts a diagram illustrating an example of a system 100 consistent with some implementations of the current subject matter. Referring to FIG. 1, the system 100 may include a plurality of cloud platforms 110A-D. Each of the cloud platforms may provide resources that can be shared among a plurality of tenants. For example, the cloud platforms 110A-D may be configured to provide a variety of services including, for example, software-as-a-service (SaaS), platform-as-a-service (PaaS), infrastructure as a service (IaaS), database as a service (DaaS), and/or the like, and these services can be accessed by one or more tenants (labeled clients) of the cloud platform. The system 100 includes a repository 220 which stores versions of table(s) changed at the system 100.

In the example of FIG. 1, the system 100 includes a first tenant 140A, a second tenant 140B, and a third tenant 140C, although other quantities of tenants (which as noted are labeled as clients) may be implemented as well on the cloud platform 110A. A user may access the client, and the clients may each comprise a user device (e.g., a computer including an application such as a browser or other type of application). And, the clients may each access, via the Internet and/or other type of network or communication link(s), at least one of the services at a cloud platform, such as cloud platforms 110A-D. In some implementations, each of the clients/tenants 140A-C represents a separate tenant at the cloud platform 110A for example, such that a tenant's data is not shared with other tenants (absent permission from a tenant). Alternatively, each of the tenants 140A-C may represent a single entity at the cloud platform 110A, such that the tenants do share a portion of the entity's data, for example.

The cloud platform 110A may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources.

In the case of a cloud platform being a so-called “public” cloud platform, the services may be provided on-demand to a client, or tenant, via the Internet. For example, the resources at the public cloud platform may be operated and/or owned by a cloud service provider (e.g., Amazon Web Services™, Microsoft Azure™, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110A includes a service 112A, which is provided to for example the client 140A (or one of the other clients 140B). This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which includes the database instances 114A-C, also referred to more simply as databases) and the application layer, such as application 112B, which in this example is a multitenant application at the cloud platform 110A.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database 114A may be accessed as a service at a cloud platform, which may be the same or different platform from cloud platform 110A. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110A. Although the database instances are depicted at the same cloud platform 110A, one or more of the database instances may be hosted on another or separate platform (e.g., on-premise) and/or another cloud platform. Moreover, the service provided at the cloud platform may include other types of applications, such user interface applications, and the like.

The cloud platforms 110A-D may (as noted) be implemented using different technologies. As such, a system having heterogeneous cloud platforms may include for example, deployments at a SAP cloud, Microsoft Azure™, Amazon Web Services™, Google Cloud Platform™ data centers, a private data center, and/or the like. The heterogeneous cloud platform technology represents a multi-cloud system. In the case of database instances and/or their clients, some may be deployed at different private data centers (each of which may have different cloud platform technology, protocols, and the like), while some may be deployed at private data centers.

Moreover, the databases instances at the cloud platform may rely on the same or different storage or database technology. For example, a database management system instance may be an online transaction processing (OLTP) system using a relational database system. An example of an OLTP system is the SAP S/4HANA™ enterprise resource planning (ERP) system. Furthermore, the database management system instance may operate using for example the same or different storage technology, such as a row-oriented database system, a column-oriented database system, or a hybrid row-column store approach. Alternatively, or additionally, the database management system instance may be for example an online analytic processing (OLAP) system. Applications of OLAP systems include business reporting for sales, marketing, management reporting, business process management (BPM), budgeting, forecasting, financial reporting, and/or other types of analytics. An example of the OLAP system is the SAP BW/4HANA™ data warehouse solution, which can be used to for example answer multi-dimensional analytical (MDA) queries.

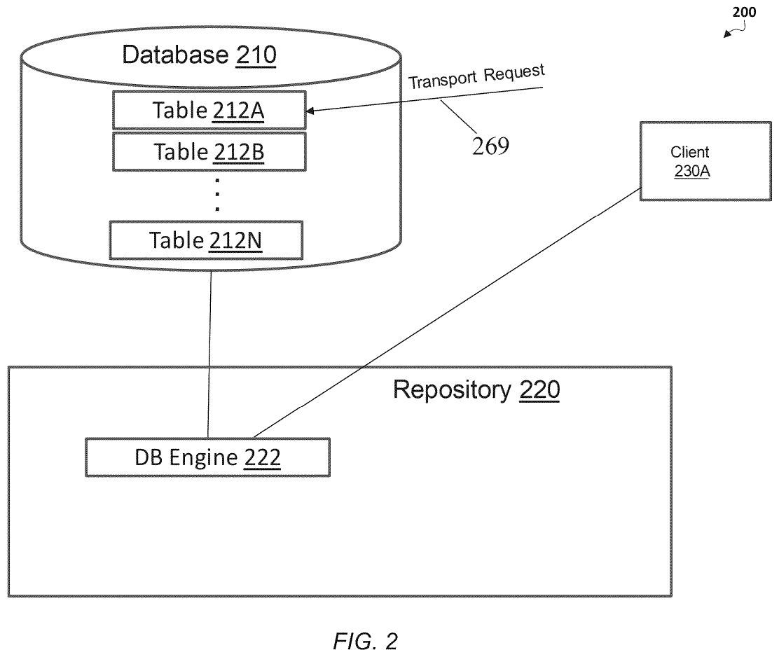

FIG. 2 depicts an example of a system 200 including a repository for file based source code management, in accordance with some embodiments. In the example of FIG. 2, the repository 220 is used to track and store changes to the database tables 212A-N of the database 210, which may provide a persistence layer (such as a database instance 114A) to a service, such as service 112A, or an ERP system, and/or the like. The repository 220 may include a database engine 222 that provides a database interface towards the system 200 (which includes database 210) and a persistent store or repository that stores each version of a given table.

In the example of FIG. 2, the database engine 222 emulates the files at the branch store 226 as database tables and provides a database interface towards the system 200, for example. In some implementations, the database engine 222 may be called via a query. The files at the repository 220 may be accessed (e.g., for read and/or write) via, for example, SQL statements for database tables. Alternatively, or additionally, the database engine 222 may be called via an OData service call (e.g., a get, post, put, patch, or delete verb carried by HTTP).

To illustrate further, an ERP system (e.g., service 112A at cloud platform 110A) may include a view layer (e.g., a view logic 112C) that decouples the ERP system from the persistency provided by the database 210 (see, e.g., database instance 114A). In this example, the ERP system may not use the database tables 212A-N directly but instead the ERP system uses a schema, such as the view layer, to read or write to the database tables. In an example, the tables 212A-N are coupled (via an OData service at API 112E) to the view layer (e.g., view logic 112C), and the OData connection (e.g., at API 112E) is coupled to the database engine 222.

In the example of FIG. 2, the database 210 may include a plurality of database tables 212A-N (or “tables” for short). For example, the database 210 may have hundreds if not thousands of tables. Each of these tables may change over time. Moreover, some of the tables may be associated with an “operational” system, such as a live system currently in use, while other tables may be associated with a test system (and/or a development system). When there is a transport request 269 (e.g., a change request) to a database table, this change may change the content of at least a portion of the database tables. These database tables may be referred to as customizing tables as the database tables include data customized (or unique) to the end user. In response to a change at a given table, such as table 212A, this may trigger a process to store in the repository 220 the change. For example, when a change to table 212A occurs, this change may be projected into the database engine 222 of the repository 220. For example, view logic 112C may, via an OData interface at 112E, send the change to the repository 220.

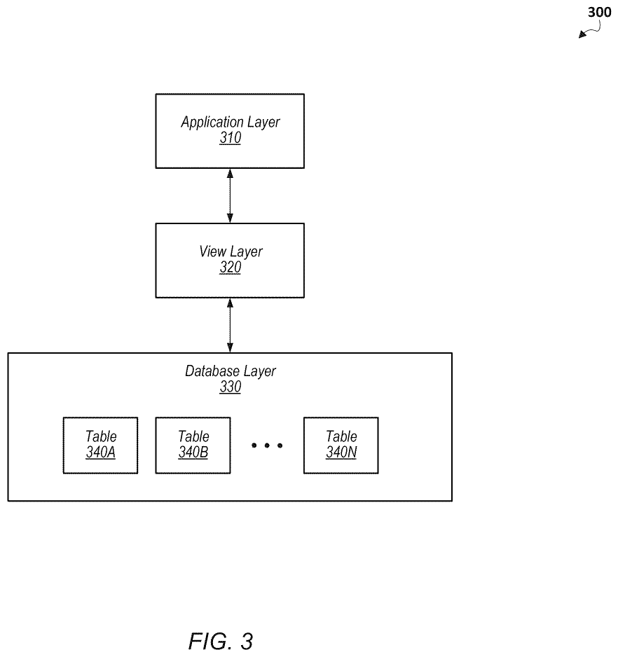

Referring now to FIG. 3, a logical block diagram of a database system 300 is shown, in accordance with one or more embodiments of the current subject matter. As shown, database system 300 includes application layer 310, view layer 320, and database layer 330. Application layer 310 includes any number of software applications that are executing on one or more computing systems. Database layer 330 includes any number of database tables 340A-N, with table 340A, table 340B, and table 340N shown in FIG. 3. These tables 340A-N are representative of any number and type of database tables. View layer 320 links the application layer 310 to the data in the database layer 330. In this manner, reads and writes to the database from application layer 310 will pass through view layer 320. Accordingly, view layer 320 decouples the direct data from the application software. View layer 320 may include view logic which includes or accesses a database schema in order to access tables 340A-N of database layer 330. The view logic may include instructions (e.g., rules, definitions, code, script, and/or the like) that can define how to handle the access to the database layer 330 and retrieve the desired data from the database layer 330. In an example, a business configuration may be stored as a set of tables in the database layer 330.

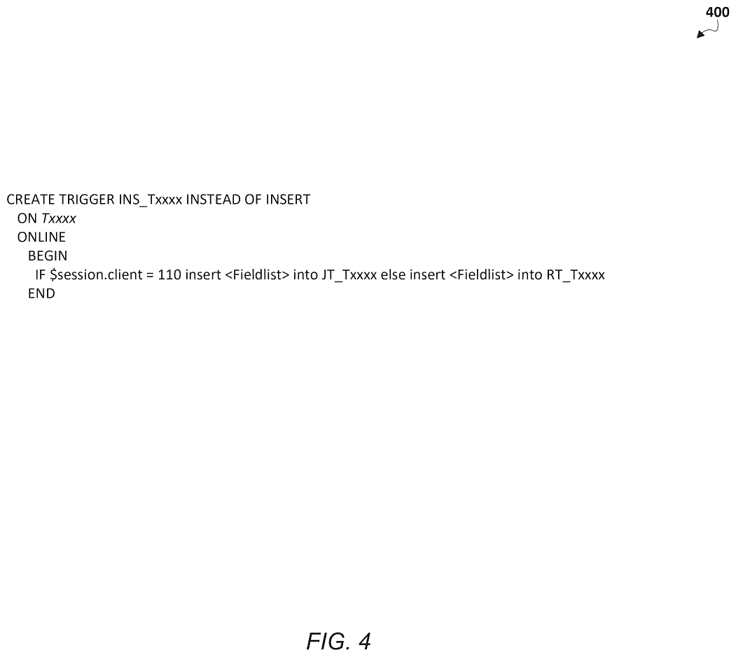

Turning now to FIG. 4, an example of an INSTEAD-OF-INSERT trigger 400 is shown, in accordance with one or more embodiments of the current subject matter. In an example, to enable insert clauses for a table, INSTEAD-OF-INSERT trigger 400 may be created for a SQL view of the table. For update, delete, or upsert, equivalent triggers may be created.

Instead-of-triggers are special stored procedures that may be configured to override a default action of a triggering statement (e.g., INSERT, UPDATE, DELETE) and perform one or more user-defined actions. The instead-of-trigger may be configured to be executed each time a data modification statement executes on a specific view. A single instead-of-trigger may be configured to apply to one specific triggering action and/or may apply to multiple actions, in which the same trigger may be configured to execute all listed actions. Further, instead-of-triggers may be configured to use one or more logical inserted and/or deleted tables to store one or more modified records while the trigger is active. Each column in these tables may be configured to map directly to a column in a base view referenced in the trigger. For example, if a view named V₁ includes columns named C₁, C₂, and C₃, the inserted and/or deleted tables contain values for all of these columns, even if the trigger modifies only column C₂. Further, an instead-of-trigger may be configured to be executed only once per data modification statement. A query containing a WHILE loop may repeat an update and/or insert such data modification statement many times, thereby executing the instead-of-trigger each time.

For the INSTEAD-OF-INSERT trigger 400 shown in FIG. 4, the application program will work in the original table, if the call is coming out of any client unequal to 110. In an example, the original table is a relational table. If the call is started from client 110, the selected data is written to the corresponding JSON_TABLE. In case of a software upgrade to the system, a search for programs may be performed, changing configuration data as the last upgrade step. These programs are called XPRA.

For each XPRA, it is known which tables are read and written during the software upgrade. For these tables, the above mentioned views are generated. Then, the XPRAs are triggered in client 110. This modifies the data in the JSON_TABLEs. After the XPRAs are run, the data is extracted from the JSON_TABLEs and retransferred into the GIT repository, where a commit statement is executed to finalize the state.

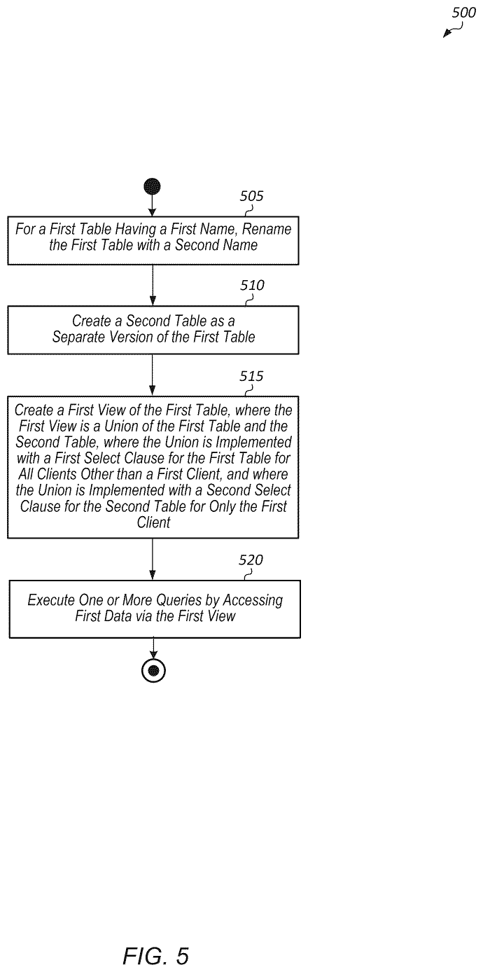

Referring now to FIG. 5, a process is depicted for creating a view of a union of multiple tables, in accordance with one or more embodiments of the current subject matter. For a first table having a first name, the first table is renamed with a second name (block 505). In an example, the first table stores configuration data for an enterprise resource planning software application. In other examples, the first table may store any of various other types of data. In an example, for a first table with the name of Txxxx, the first table is renamed to RT_Txxxx.

Also, a second table is created as a separate version of the first table (block 510). The second table may have a third name which is different from the first name and the second name. In some embodiments, the second table may be a different type of table than the first table. In other words, the first table is a first type of table and the second table is a second type of table, where the second type of table is supported by both a version repository and by a database underneath the ERP system. In an example, the second table is a JavaScript Object Notation (JSON) table and the first table is a non-JSON table (e.g., column store table). In other examples, the second table may be any of various other types of tables. In the example where the first table has the original name of Txxxx, the second table may be named JT_Txxxx.

Next, a first view is created of the first table, where the first view is a union of the first table and the second table, where the union is implemented with a first select clause for the first table for all clients other than a first client, and where the union is implemented with a second select clause for the second table for only the first client (block 515). As used herein, a “view” or a “database view” may be defined as a searchable object in a database that includes a result of a query on the database. In an example, a “database view” does not store any data but may nevertheless operate akin to a “virtual table” in that the “database view” itself may be queried. In an example, a view is a relation defined in terms of stored base tables.

In an example, the view created in block 515 is a structured query language (SQL) view, and the SQL view may be named Txxxx. Additionally, in an example, the first select clause may be the following: Select from RT_Txxxx where <where-clause> and $session.client<> 110. It is assumed that the first client is client 110 in this example. In this example, the second clause may be the following: Select from JT_Txxxx where <where-clause> and $session.client=110. These statements allow for data to be read from the second table for client 110 and from the first table for all other clients.

After block 515, one or more queries are executed by accessing first data via the first view (block 520). After block 520, method 500 may end.

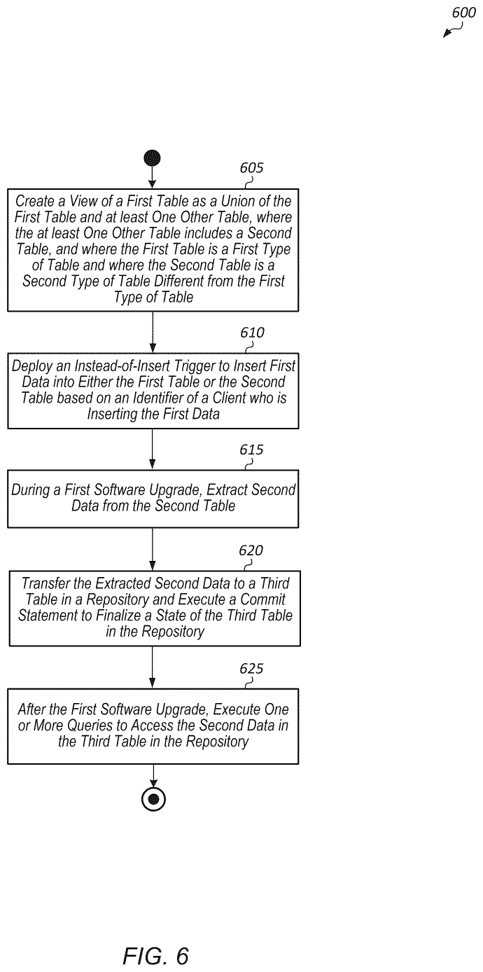

Turning now to FIG. 6, a process is depicted for performing an upgrade operation of non-imported configuration data in a repository, in accordance with one or more embodiments of the current subject matter. A first application creates a view of a first table as a union of the first table and at least one other table, wherein the at least one other table includes a second table, and wherein the first table is a first type of table and the second table is a second type of table different from the first type of table (block 605). In an example, the first table is a relational table and the second table is a JSON table. In an example, the first table stores configuration data for an enterprise resource planning software application. Next, the first application deploys an instead-of-insert trigger to insert first data into either the first table or the second table based on an identifier of a client who is inserting the first data (block 610). Then, during a first software upgrade, second data is extracted from the second table (block 615). Next, the extracted second data is transferred to a third table in a repository and a commit statement is executed to finalize a state of the third table in the repository (block 620). In an example, the repository is a versioning repository (e.g., a Git repository). Then, after the first software upgrade, one or more queries are executed by the first application to access the second data in the third table in the repository (block 625). After block 625, method 600 may end.

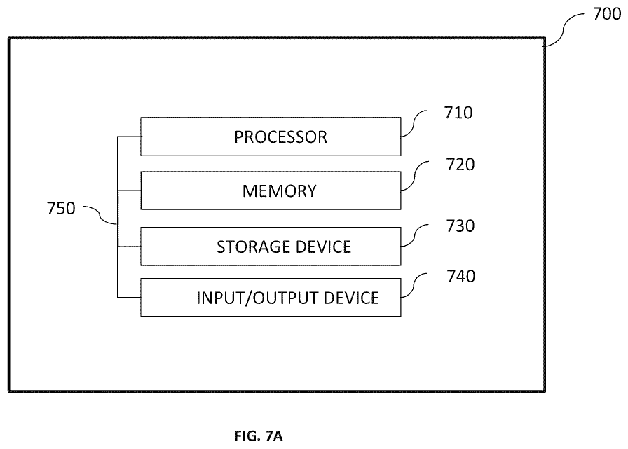

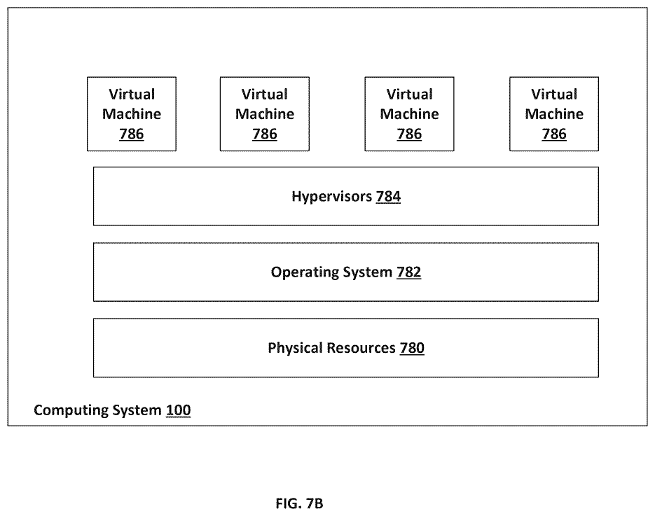

In some implementations, the current subject matter may be configured to be implemented in a system 700, as shown in FIG. 7A. The system 700 may include a processor 710, a memory 720, a storage device 730, and an input/output device 740. Each of the components 710, 720, 730 and 740 may be interconnected using a system bus 750. The processor 710 may be configured to process instructions for execution within the system 700. In some implementations, the processor 710 may be a single-threaded processor. In alternate implementations, the processor 710 may be a multi-threaded processor. The processor 710 may be further configured to process instructions stored in the memory 720 or on the storage device 730, including receiving or sending information through the input/output device 740. The memory 720 may store information within the system 700. In some implementations, the memory 720 may be a computer-readable medium. In alternate implementations, the memory 720 may be a volatile memory unit. In yet some implementations, the memory 720 may be a non-volatile memory unit. The storage device 730 may be capable of providing mass storage for the system 700. In some implementations, the storage device 730 may be a computer-readable medium. In alternate implementations, the storage device 730 may be a floppy disk device, a hard disk device, an optical disk device, a tape device, non-volatile solid state memory, or any other type of storage device. The input/output device 740 may be configured to provide input/output operations for the system 700. In some implementations, the input/output device 740 may include a keyboard and/or pointing device. In alternate implementations, the input/output device 740 may include a display unit for displaying graphical user interfaces.

FIG. 7B depicts an example implementation of the computing system 100 (of FIG. 1). The computing system 100 may be implemented using various physical resources 780, such as at least one or more hardware servers, at least one storage, at least one memory, at least one network interface, and the like. The computing system 100 may also be implemented using infrastructure, as noted above, which may include at least one operating system 782 for the physical resources 780 and at least one hypervisor 784 (which may create and run at least one virtual machine 786). For example, each multitenant application may be run on a corresponding virtual machine 786.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

### Example 1

A system comprising: at least one processor; and at least one memory storing instructions that, when executed by the at least one processor, cause operations comprising: for a first table having a first name, renaming the first table with a second name; creating a second table as a separate version of the first table; creating a first view of the first table, wherein the first view is a union of the first table and the second table, wherein the union is implemented with a first select clause for the first table for all clients other than a first client, and wherein the union is implemented with a second select clause for the second table for only the first client; and executing one or more queries by accessing first data via the first view.

### Example 2

The system of Example 1, wherein the first table stores configuration data for an enterprise resource planning software application, and wherein the second table has a third name.

### Example 3

The system of any of Examples 1-2, wherein the operations further comprise deploying an instead-of-insert trigger to insert second data into either the first table or the second table based on an identifier associated with a client who is inserting the second data.

### Example 4

The system of any of Examples 1-3, wherein the operations further comprise: during a first software upgrade, extracting second data from the second table; and transferring the second data to a third table in a repository.

### Example 5

The system of any of Examples 1-4, wherein the first software upgrade is associated with a first software application.

### Example 6

The system of any of Examples 1-5, wherein the operations further comprise executing a commit statement to finalize a state of the third table in the repository.

### Example 7

The system of any of Examples 1-6, wherein the operations further comprise inserting second data in the second table if the first client is inserting the second data.

### Example 8

The system of any of Examples 1-7, wherein the first client is a development client.

### Example 9

The system of any of Examples 1-8, wherein the operations further comprise inserting third data in the renamed first table if a second client is inserting the third data.

### Example 10

The system of any of Examples 1-9, wherein the second client is a test client.

### Example 11

The system of any of Examples 1-10, wherein the second client is a production client.

### Example 12

A computer-implemented method comprising: for a first table having a first name, renaming the first table with a second name; creating a second table as a separate version of the first table; creating a first view of the first table, wherein the first view is a union of the first table and the second table, wherein the union is implemented with a first select clause for the first table for all clients other than a first client, and wherein the union is implemented with a second select clause for the second table for only the first client; and executing one or more queries by accessing first data via the first view.

### Example 13

The computer-implemented method of Example 12, wherein the first table stores configuration data for an enterprise resource planning software application, and wherein the second table has a third name.

### Example 14

The computer-implemented method of any of Examples 12-13, further comprising deploying an instead-of-insert trigger to insert second data into either the first table or the second table based on an identifier associated with a client who is inserting the second data.

### Example 15

The computer-implemented method of any of Examples 12-14, further comprising: during a first software upgrade, extracting second data from the second table; and transferring the second data to a third table in a repository.

### Example 16

The computer-implemented method of any of Examples 12-15, wherein the first software upgrade is associated with a first software application.

### Example 17

The computer-implemented method of any of Examples 12-16, further comprising executing a commit statement to finalize a state of the third table in the repository.

### Example 18

The computer-implemented method of any of Examples 12-17, further comprising inserting second data in the second table if the first client is inserting the second data, wherein the first client is a development client.

### Example 19

The computer-implemented method of any of Examples 12-18, further comprising inserting third data in the renamed first table if a second client is inserting the third data, wherein the second client is a test client.

### Example 20

A non-transitory computer readable storage medium storing instructions, which when executed by at least one data processor, result in operations comprising: for a first table having a first name, renaming the first table with a second name; creating a second table as a separate version of the first table; creating a first view of the first table, wherein the first view is a union of the first table and the second table, wherein the union is implemented with a first select clause for the first table for all clients other than a first client, and wherein the union is implemented with a second select clause for the second table for only the first client; and executing one or more queries by accessing first data via the first view.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
at least one processor; and
at least one memory storing instructions that, when executed by the at least one processor, cause operations comprising:
for a first table having a first name, renaming the first table with a second name;
creating a second table as a separate version of the first table;
creating a first view of the first table, wherein the first view is a union of the first table and the second table, wherein the union is implemented with a first select clause for the first table for all clients other than a first client, and wherein the union is implemented with a second select clause for the second table for only the first client; and
executing one or more queries by accessing first data via the first view.

2. The system of claim 1, wherein the first table stores configuration data for an enterprise resource planning software application, and wherein the second table has a third name.

3. The system of claim 1, wherein the operations further comprise deploying an instead-of-insert trigger to insert second data into either the first table or the second table based on an identifier associated with a client who is inserting the second data.

4. The system of claim 1, wherein the operations further comprise:
during a first software upgrade, extracting second data from the second table; and
transferring the second data to a third table in a repository.

5. The system of claim 4, wherein the first software upgrade is associated with a first software application.

6. The system of claim 4, wherein the operations further comprise executing a commit statement to finalize a state of the third table in the repository.

7. The system of claim 1, wherein the operations further comprise inserting second data in the second table if the first client is inserting the second data.

8. The system of claim 7, wherein the first client is a development client.

9. The system of claim 8, wherein the operations further comprise inserting third data in the renamed first table if a second client is inserting the third data.

10. The system of claim 1, wherein the second client is a test client.

11. The system of claim 1, wherein the second client is a production client.

12. A computer-implemented method comprising:
for a first table having a first name, renaming the first table with a second name;
creating a second table as a separate version of the first table;
creating a first view of the first table, wherein the first view is a union of the first table and the second table, wherein the union is implemented with a first select clause for the first table for all clients other than a first client, and wherein the union is implemented with a second select clause for the second table for only the first client; and
executing one or more queries by accessing first data via the first view.

13. The computer-implemented method of claim 12, wherein the first table stores configuration data for an enterprise resource planning software application, and wherein the second table has a third name.

14. The computer-implemented method of claim 12, further comprising deploying an instead-of-insert trigger to insert second data into either the first table or the second table based on an identifier associated with a client who is inserting the second data.

15. The computer-implemented method of claim 12, further comprising:
during a first software upgrade, extracting second data from the second table; and
transferring the second data to a third table in a repository.

16. The computer-implemented method of claim 15, wherein the first software upgrade is associated with a first software application.

17. The computer-implemented method of claim 15, further comprising executing a commit statement to finalize a state of the third table in the repository.

18. The computer-implemented method of claim 12, further comprising inserting second data in the second table if the first client is inserting the second data, wherein the first client is a development client.

19. The computer-implemented method of claim 18, further comprising inserting third data in the renamed first table if a second client is inserting the third data, wherein the second client is a test client.

20. A non-transitory computer readable storage medium storing instructions, which when executed by at least one data processor, result in operations comprising:
for a first table having a first name, renaming the first table with a second name;
creating a second table as a separate version of the first table;
creating a first view of the first table, wherein the first view is a union of the first table and the second table, wherein the union is implemented with a first select clause for the first table for all clients other than a first client, and wherein the union is implemented with a second select clause for the second table for only the first client; and
executing one or more queries by accessing first data via the first view.
